(19) United States
(12) Patent Application Publication
(10) Pub. No.: US 2011/0161362 A1
(43) Pub. Date: Jun. 30, 2011

(54) DOCUMENT ACCESS MONITORING

(76) Inventors: Guy Michael Lipscombe, London (GB); Marcin Jan Skup, Bologna (IT)

(21) Appl. No.: 13/001,003

(22) PCT Filed: Jun. 18, 2009
(86) PCT No.: PCT/GB09/50698

§ 371 Date: Mar. 14, 2011

(30) Foreign Application Priority Data
Jun. 23, 2008 (GB) 0811503.2

(51) Int. Cl. G06F 17/30

(52) U.S. Cl. 707/769; 707/E17.014

(57) ABSTRACT

A method of monitoring access to a set of documents stored on one or more document servers distributed across a network to which is coupled one or more document access logging databases for logging each access to each of the set of documents is disclosed. The method comprises: a) receiving from a client a request to access a user survey document comprising data defining one or more input fields and an executable element, which on execution causes predetermined access logging data including at least a unique user identification number to be stored in at least one of the document access logging databases along with a corresponding unique client identification number; b) serving the user survey document to the client for processing in response to the request and for executing the executable element; c) receiving from the client the unique user identification number along with input data entered into the one or more input fields; and d) storing the received input data and the unique user identification number together in a survey database. A corresponding system for performing the method is also disclosed.

This invention relates to a system and method for monitoring access to a set of documents stored on one or more document servers distributed across a network to which is coupled one or more document access logging databases for logging each access to each of the set of documents.

Many website owners make use of techniques for monitoring the access of the documents stored on their website. These techniques are generically known as “Web analytics”, and the techniques are normally made available to website owners by third party vendors.

A typical web analytics process uses a JavaScript tag which is provided by the third party vendor to a website owner for embedding in one or more web pages of which he wishes to monitor the access. The JavaScript tag will include a series of unpopulated variables, which the website owner may populate to indicate amongst other things the particular web page which is being monitored.

Whenever this web page is served to a browser running on a remote client, the browser executes the JavaScript tag which sends a request to the web analytics vendor's server. This server in response to the request checks for the existence of a unique client identification number, generally stored in a persistent cookie on the remote client.

If the unique client identification number does not exist then the server generates one, logs the access of the web page (typically by storing information designating the web page and the date and time of the access) in a web analytics database along with the new client identification number and sends the identification number back to the remote client inside a persistent cookie for use in monitoring future access of documents by this client.

If on the other hand the unique client identification number does exist then it is simply logged along with the access of the web page.

Other information that may be stored in the web analytics database include the section name (for example, this may be the “News” or “Sport” section of a newspaper's website) and the server name which actually served the web page.

Although web analytics provides information about the rate and quantity of accesses of a web page made by a client device and it can help in tracking the browsing history of that client device, it provides no information at all about the user of that device. It is therefore not possible to use this information for example to analyse the type of individual who has accessed a page since the information does not include any demographic breakdown of the users. It is possible to gather and store in a database information about users for generating a demographic breakdown, for example by surveying. However, what is needed is a way of linking this information about users with the corresponding browsing history for those users. Then it would be possible to analyse the type of individual that has actually accessed certain websites or indeed web pages and use this as the basis for deciding what type of content would be most appropriate for those individuals. Typically, of course the analysis will be used to decide on suitable types of marketing content, such as advertisements.

It Is theoretically possible to make this link based on the unique client identification number which is stored in a persistent cookie. However, this is unreliable since a significant proportion of users block persistent cookies, or the cookie may be deleted.

Furthermore, if the user browses to a site which uses a different web analytics provider then it is impossible for the first provider to track this and therefore to gain a complete picture of the browsing history of the device.

In a first aspect of the invention, there is provided a method of monitoring access to a set of documents stored on one or more document servers distributed across a network to which is coupled one or more document access logging databases for logging each access to each of the set of documents, the method comprising:

a) receiving from a client a request to access a user survey document comprising data defining one or more input fields and an executable element, which on execution causes predetermined access logging data including at least a unique user identification number to be stored in at least one of the document access logging databases along with a corresponding unique client identification number;

b) serving the user survey document to the client for processing in response to the request and for executing the executable element;

c) receiving from the client the unique user identification number along with input data entered into the one or more input fields; and

d) storing the received input data and the unique user identification number together in a survey database.

In a second aspect there is provided a system for monitoring access to a set of documents stored on one or more document servers distributed across a network to which is coupled one or more document access logging databases for logging each access to each of the set of documents, the system comprising a server coupled to the network in use, the server being adapted to:

a) receive from a client a request to access a user survey document comprising data defining one or more input fields and an executable element, which on execution causes predetermined access logging data including at least a unique user identification number to be stored in at least one of the document access logging databases along with a corresponding unique client identification number;

b) serve the user survey document to the client for processing in response to the request and for executing the executable element;

c) receive from the client the unique user identification number along with input data entered into the one or more input fields; and

d) store the received input data and the unique user identification number together in a survey database.

The invention provides a way of gathering information about a user and associating it with a unique user identification number, which is stored alongside the user-provided information in a database. The unique user identification number is also stored in the web analytics database (referred to as the document access logging database). The data in the two databases may therefore be linked by virtue of the common unique user identification number.

However, it is not possible to block the unique user identification number from being included in the data sent to the document access logging databases or the survey databases. The invention therefore overcomes the abovementioned problem with blocking or deletion of cookies and provides a reliable way of linking demographic information at a user level with the web analytics information.

Furthermore, since the same unique user identification number may be posted to several document access logging databases operated by different companies, it is possible to improve the tracking of the web browsing history of a user.

The usual case is that the executable element will cause the predetermined access logging data to be stored in only one document access logging database. However, it is possible that it could cause the predetermined access logging data to be stored in multiple document access logging databases, some or all of which may be provided by different vendors.

It should be understood that whilst we have referred to a unique user identification “number” and a unique client identification “number” it is possible that either or both of these will contain elements that are not numbers such as alphabetic or alphanumeric characters. Indeed, any information that can uniquely identify a user, such as their name and date of birth, may be used as the unique user identification number.

The unique user identification number may be generated from user input entered by a user in the one or more input fields. Alternatively, it may be generated by one of the document access logging databases. However, in a preferred embodiment, the user survey document comprises the unique user identification number, which is generated in response to the request.

In this preferred embodiment, the unique user identification number is typically embedded in the user survey document as a hidden input field. The server may therefore be further adapted to embed the unique user identification number in the user survey document as a hidden input field.

Normally, each of the set of documents and the user survey document is written using a markup language such as hypertext markup language (HTML). Alternatively, the user survey document may be written using another language such as Adobe® Flash or JavaScript.

Preferably, the unique user identification number is randomly generated and comprises a string of characters. The server may therefore be further adapted to randomly generate a string of characters to form the unique user identification number. The string of characters may be alphanumeric, or indeed any combination of alphabetic, numeric or other characters.

Typically, the executable element comprises a portion written using a scripting language, such as JavaScript.

However, the executable element may instead or in addition comprise a markup language tag which causes a tracking document to be embedded in the user survey document, the embedding of the tracking document causing the predetermined access logging data including at least the unique user identification number to be stored in at least one of the document access logging databases along with the corresponding unique client identification number.

The method may further comprise merging the access logging data from at least one of the document access logging databases and the received input data from the survey database using the unique user identification number as a key. To achieve this, the system may further comprise a processor for merging the access logging data from at least one of the document access logging databases and the received input data from the survey database using the unique user identification number as a key.

In a third aspect of the invention, there is a computer program adapted to perform the method of the first aspect when executed on a computer.

In a fourth aspect of the invention, a computer program product comprises a computer program adapted to perform the method of the first aspect when the computer program is executed on a computer. In this aspect, it is important to realise that the computer program product may be a conventional computer media, such as a CD-ROM, or it may comprise packets of data transmitted over a network, such as the Internet.

Embodiments of the invention will now be described with reference to the accompanying drawings, in which:

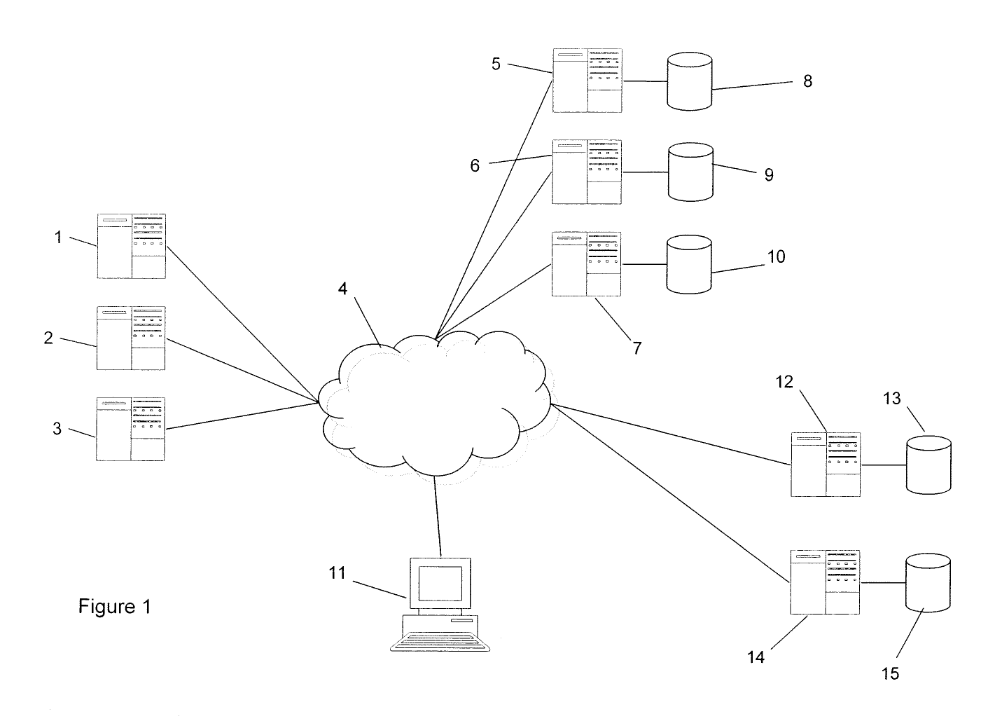

FIG. 1 shows details of a system for performing the invention.

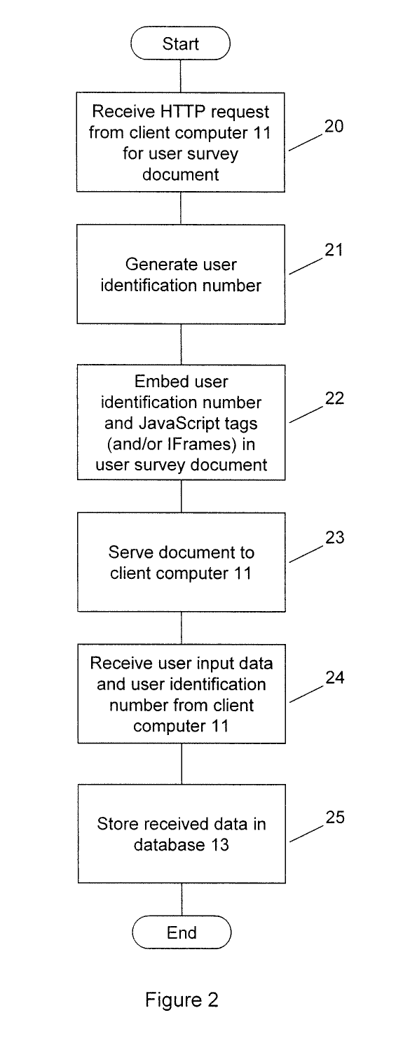

FIG. 2 shows a flow chart of a method according to a first embodiment of the invention.

In FIG. 1, there are three web servers 1, 2 and 3 each of which is connected to a distributed network 4 such as the Internet. Each of the web servers 1, 2 and 3 is operated by a different website owner and is adapted to serve web pages in response to hypertext transfer protocol (HTTP) requests received over the network 4. Each of the web pages is written using hypertext markup language (HTML).

Alongside the content intended for viewing, some of the web pages on each of servers 1 2 and 3 contain executable JavaScript tags, which are executed by browser software when the HTML code is rendered. The JavaScript tags cause a request to be sent to a web analytics server 5, 6 or 7 to record the access of the web page. Each of the web analytics servers 5, 6 and 7 will typically be operated by different organisations.

For example, web server 1 may comprise a first web page which the owner wishes to monitor the access of. This web page will contain a JavaScript tag. When the page is served to a browser, the JavaScript is executed causing a request to be made to web analytics server 5 to record the access of the first web page. The access is recorded by web analytics server 5 in the attached database 8. The database entry will contain the time and date of the access and information identifying the first web page along with a unique client identification number (which identifies the client device on which the browser is operating). The client identification number is generated in the manner explained above with reference to the prior art, although the particular method by which it is generated and stored is irrelevant to the invention.

Web servers 2 and 3 may also contain second and third web pages respectively, each of which includes respective JavaScript tags. The JavaScript tag in the second web page causes the access to be logged by web analytics server 6 in attached database 9, whereas the JavaScript tag in the third web page causes the access to be logged by web analytics server 7 in attached database 10.

Each of the web analytics servers 5, 6 and 7 may be queried to find out how many unique clients have been used to access the first, second or third web pages, how many accesses have been made to each of these pages, and to track the browsing history of a client across these web pages. Obviously, this example is trivial in scale, and in a practical situation the web analytics servers 5, 6 and 7 would log accesses to many thousands of web pages stored on a much larger number of web servers.

FIG. 1 also shows a client computer 11 which can execute browser software capable of making HTTP requests over network 4 to any of web servers 1, 2 or 3 to access any of the web pages stored on them. Thus, client computer 11 may access any of the first, second or third web pages mentioned above and cause corresponding access logs to be made in the databases 8, 9 and 10 connected to web analytics servers 5, 6 and 7. As already mentioned, the client computer 11 will be provided with a unique client identification number by each of these web analytics servers 5, 6 and 7, and these identification numbers will typically be stored on the client computer 11 in respective cookies.

In this example, the third web page referred to above may comprise a hyperlink allowing a user of the client computer 11 to take part in a survey. If the user selects this hyperlink then the method shown in the flowchart of FIG. 2 and explained below will be invoked.

The target of the hyperlink is another web server 12 which receives an HTTP request from the client computer 11 as a result of the hyperlink being selected. This is shown in step 20. In response to the request, the web server 12 generates a unique user identification number in step 21. The user identification number is randomly generated and typically comprises an alphanumeric string of characters.

The user identification number is then embedded in step 22 as a hidden input field in a user survey document. The user survey document is written in HTML and comprises a set of questions and associated input fields for a user to provide a response to each of the questions. It also comprises three JavaScript tags, each of which includes reference to the unique user identification number. The user survey document is then served to the client computer 11 in step 23.

When the client computer 11 receives the user survey document, the browser renders the HTML code to display the questions and associated input fields to the user. The user may then provide answers to each of the questions and submit the answers to the web server 12. Because the user identification number is embedded in the user survey document in a hidden input field it is not rendered visible to the user by the browser. However, when the user submits the answers to the web server 12, the user identification number is also submitted as an input field. This provides a way of uniquely identifying each set of answers to a particular user. The submitted answers and user identification number are received by web server 12 in step 24 and then stored in connected database 13 in step 25.

The user survey document may contain a variety of questions depending on its purpose. Typical questions may be designed to obtain demographic information. Example questions include asking users for their country of residence, their age, their gender, what media (e.g. newspapers and television programmes) they consume, what products and type of product they own and questions about their lifestyle.

As it renders the user survey document, the browser running on client computer 11 executes the three JavaScript tags. Each of these causes a request to log the access to the user survey document to a respective one of web analytics servers 5, 6 and 7. The web analytics servers 5, 6 and 7 each respond by recording the access to the user survey document along with the date and time of the access and the unique client identification number (stored in cookies on the client computer 11) in their respective connected databases 8, 9 and 10. However, since the JavaScript tags each include the user identification number, the web analytics servers 5, 6 and 7 store the user identification number alongside the other recorded information in databases 8, 9 and 10.

FIG. 1 shows another server 14 connected to the network 4. This server is operable to run a query on each of the web analytics servers 5, 6 and 7 to retrieve every record stored on databases 8, 9 and 10 for which a unique user identification number is recorded. Since the same user identification number has been stored against the three different client identification numbers provided by each of the web analytics servers 5, 6 and 7, the data in each of the databases 8, 9 and 10 is linked by a common key. This allows the browsing history of users to be monitored and then subsequently retrieved across websites for which access is logged by different web analytics providers.

The survey results for each of these user identification numbers is stored in database 13. Server 14 can therefore also query server 12 to retrieve the survey results for each of the user identification numbers and merge the results with the results of the queries run on web analytics servers 5, 6 and 7 using the user identification number as a key. The merged results can then be stored in database 15.

The database 15 can then be queried to retrieve a combination of the survey results (which may for example include demographic information relating to the users) and information relating to their browsing history (for example, how often and when they visit a particular website, what types of website they visit etc.).

In another embodiment, the user survey document does not make use of JavaScript tags for recording the access of the user survey document. Instead, it makes use of IFrames, which are a feature of HTML.

In this embodiment, in step 22 instead of inserting the JavaScript tags, three IFrames are added to the user survey document. IFrames are a way of embedding a frame from another web server within the document containing the IFrame. In this case, each of the three IFrames retrieves a blank document from each of web servers 1, 2 and 3. The serving of the documents by web servers 1, 2 and 3 is logged by the web servers 1, 2 and 3 themselves. In this embodiment, the web analytics servers 5, 6 and 7 are not required and the web analytics function is carried out by the web servers 1, 2 and 3 themselves (or computers connected to them).

It is possible that in a variant of this embodiment, the document retrieved by the IFrame will not be blank. Indeed, it may contain text or other content such as JavaScript code.

It is envisaged that this embodiment will be rarely used as most large organisations make use of third party web analytics providers. However, it is required when the web server logs themselves are used as the data for web analytics purposes and the web server needs to serve a page in order for that to be logged. Alternatively, it may be required if the unique client identification number is stored in a first party cookie which can only be retrieved by the web server itself.

It is of course possible to make use of a combination of both embodiments at the same time. For example, the user survey document may contain both JavaScript tags and IFrames.

1. A method of monitoring access to a set of documents stored on one or more document servers distributed across a network to which is coupled one or more document access logging databases for logging each access to each of the set of documents, the method comprising:
a) receiving from a client computer a request to access a user survey document comprising data defining one or more input fields and an executable element, which on execution causes predetermined access logging data including at least a unique user identification number to be stored in at least one of the document access logging databases along with a corresponding unique client identification number;
b) serving the user survey document to the client computer for processing in response to the request and for executing the executable element;
c) receiving from the client computer the unique user identification number along with input data entered into the one or more input fields; and
d) storing the received input data and the unique user identification number together in a survey database.

2. A method according to claim 1, wherein the user survey document comprises the unique user identification number, which is generated in response to the request.

3. A method according to claim 2, wherein the unique user identification number is embedded in the user survey document as a hidden input field.

4. A method according to claim 1, wherein each of the set of documents and the user survey document is written using a markup language such as hypertext markup language (HTML).

5. A method according to claim 1, wherein the unique user identification number is randomly generated and comprises a string of characters.

6. A method according to claim 1, wherein the executable element comprises a portion written using a scripting language.

7. A method according to claim 1, wherein the executable element comprises a markup language tag which causes a tracking document to be embedded in the user survey document, the embedding of the tracking document causing the predetermined access logging data including at least the unique user identification number to be stored in at least one of the document access logging databases along with the corresponding unique client identification number.

8. A method according to claim 1, further comprising merging the access logging data from at least one of the document access logging databases and the received input data from the survey database using the unique user identification number as a key.

9. A system for monitoring access to a set of documents stored on one or more document servers distributed across a network to which is coupled one or more document access logging databases for logging each access to each of the set of documents, the system comprising a server coupled to the network in use, the server being adapted to:
a) receive from a client a request to access a user survey document comprising data defining one or more input fields and an executable element, which on execution causes predetermined access logging data including at least a unique user identification number to be stored in the at least one of the document access logging databases along with a corresponding unique client identification number;
b) serve the user survey document to the client for processing in response to the request and for executing the executable element;
c) receive from the client the unique user identification number along with input data entered into the one or more input fields; and
d) store the received input data and the unique user identification number together in a survey database.

10. A system according to claim 9, wherein the user survey document comprises the unique user identification number, which is generated in response to the request.

11. A system according to claim 10, wherein the server is further adapted to embed the unique user identification number in the user survey document as a hidden input field.

12. A system according to claim 9, wherein each of the set of documents and the user survey document is written using a markup language such as hypertext markup language (HTML).

13. A system accordin claim 9, wherein the server is further adapted to randomly generate a string of characters to form the unique user identification number.

14. A system according to claim 9, wherein the executab e element comprises a portion written using a scripting language, such as JavaScript.

15. A system according to claim 9, wherein the executable element comprises a markup language tag which causes a tracking document to be embedded in the user survey document, the embedding of the tracking document causing the predetermined access logging data including at least the unique user identification number to be stored in at least one of the document access logging databases along with the corresponding unique client identification number.

16. A system according to claim 9, further comprising a processor for merging the access logging data from at least one of the document access logging databases and the received input data from the survey database using the unique user identification number as a key.

17.-20. (canceled)
